(19) United States
(12) Patent Application Publication
(10) Pub. No.: US 2025/0059950 A1
(43) Pub. Date: Feb. 20, 2025

(54) APPARATUS STATIC INERTIA COMPENSATION USING EXTERNAL ROBOTS

(71) Applicant: International Business Machines Corporation, Armonk, NY (US)

(72) Inventors: Sarbajit K. Rakshit, Kolkata (IN); Asim Munawar, Demarest, NJ (US)

(21) Appl. No.: 18/451,250

(22) Filed: Aug. 17, 2023

(51) Int. Cl. F03D 7/02; B64U 50/13; F03D 17/00

(52) U.S. Cl. CPC F03D 7/026; B64U 50/13; F03D 17/005; B64U 2101/25; B64U 2201/102; F05B 2260/85; F05B 2270/3202

(57) ABSTRACT

The present inventive concept provides for a method of apparatus static inertia compensation using external robots. The method includes identifying a region of at least one wind turbine experiencing actual or imminent static inertia. A wind speed at the region is identified. The identified wind speed is compared to a predetermined cut-in speed. An external force necessary to overcome the actual or imminent static inertia based on the compared identified wind speed and the predetermined cut-in speed is calculated. The calculated external force necessary to overcome the actual or imminent static inertia using at least one external robot is generated.

### BACKGROUND

Exemplary embodiments of the present inventive concept relate to apparatus static inertia compensation, and more particularly, to apparatus static inertia compensation using external robots.

Static inertia refers to the inertia of a body at rest, and to move said body (such as a wind turbine from a static state to a mobile state), additional force (e.g., torque) is required, like moving a vehicle from a stopped condition etc. Apparatuses, such as wind turbines, are prone to experiencing static inertia. Wind turbines are an increasingly popular source of clean and renewable energy. The power output of a wind turbine varies with wind speeds. The cut-in speed (typically between 6 and 9 mph) is the speed at which the wind turbine starts rotating and generating power that can be harnessed. In this case, if the body starts moving then we don't need additional force. As wind speeds increase, more electricity is generated until it reaches a limit, known as the rated speed. This is the point that the turbine produces its maximum, or rated power. As the wind speed increases, the power generated by the turbine remains constant until it eventually hits a cut-out speed (varies by wind turbine) and shuts down to prevent unnecessary strain on the rotor. A common reason for wind turbines to stop rotating is that the wind speed is not fast enough to overcome the static inertia. A small force is required to overcome static inertia and resume wind turbine rotation. During a rotational state, when the static inertia has been overcome, the wind turbine will start rotating with less force (wind speed) than otherwise necessary.

### SUMMARY

Exemplary embodiments of the present inventive concept relate to a method, a computer program product, and a system for apparatus static inertia compensation using external robots.

According to an exemplary embodiment of the present inventive concept, a method of apparatus static inertia compensation using external robots is provided. The method includes identifying a region of at least one wind turbine experiencing actual or imminent static inertia. A wind speed at the region is identified. The identified wind speed is compared to a predetermined cut-in speed. An external force necessary to overcome the actual or imminent static inertia based on the compared identified wind speed and the predetermined cut-in speed is calculated. The calculated external force necessary to overcome the actual or imminent static inertia using at least one external robot is generated.

According to an exemplary embodiment of the present inventive concept, a computer program product is provided. The computer program product includes one or more computer-readable storage media and program instructions stored on the one or more non-transitory computer-readable storage media capable of performing a method. The present inventive concept provides for a method of apparatus static inertia compensation using external robots. The method includes identifying a region of at least one wind turbine experiencing actual or imminent static inertia. A wind speed at the region is identified. The identified wind speed is compared to a predetermined cut-in speed. An external force necessary to overcome the actual or imminent static inertia based on the compared identified wind speed and the predetermined cut-in speed is calculated. The calculated external force necessary to overcome the actual or imminent static inertia using at least one external robot is generated.

According to an exemplary embodiment of the present inventive concept, a computer system is provided. The computer system includes one or more computer processors, one or more computer-readable storage media, and program instructions stored on the one or more of the computer-readable storage media for execution by at least one of the one or more processors capable of performing a method. The present inventive concept provides for a method of apparatus static inertia compensation using external robots. The method includes identifying a region of at least one wind turbine experiencing actual or imminent static inertia. A wind speed at the region is identified. The identified wind speed is compared to a predetermined cut-in speed. An external force necessary to overcome the actual or imminent static inertia based on the compared identified wind speed and the predetermined cut-in speed is calculated. The calculated external force necessary to overcome the actual or imminent static inertia using at least one external robot is generated.

### BRIEF DESCRIPTION OF THE DRAWINGS

The following detailed description, given by way of example and not intended to limit the exemplary embodiments solely thereto, will best be appreciated in conjunction with the accompanying drawings, in which:

FIG. 1 illustrates a schematic diagram of computing environment 100 including an apparatus static inertia compensation using external robots program 150, in accordance with an exemplary embodiment of the present inventive concept.

FIG. 2 illustrates a block diagram of components included in the apparatus static inertia compensation using external robots program 150, in accordance with an exemplary embodiment of the present inventive concept.

FIG. 3 illustrates a flowchart of a method of apparatus static inertia compensation using external robots 300, in accordance with an exemplary embodiment of the present inventive concept.

It is to be understood that the included drawings are not necessarily drawn to scale/proportion. The included drawings are merely schematic examples to assist in understanding of the present inventive concept and are not intended to portray fixed parameters. In the drawings, like numbering may represent like elements.

### DETAILED DESCRIPTION

Exemplary embodiments of the present inventive concept are disclosed hereafter. However, it shall be understood that the scope of the present inventive concept is dictated by the claims. The disclosed exemplary embodiments are merely illustrative of the claimed system, method, and computer program product. The present inventive concept may be embodied in many different forms and should not be construed as limited to only the exemplary embodiments set forth herein. Rather, these included exemplary embodiments are provided for completeness of disclosure and to facilitate an understanding to those skilled in the art. In the detailed description, discussion of well-known features and techniques may be omitted to avoid unnecessarily obscuring the presented exemplary embodiments.

References in the specification to “one embodiment,” “an embodiment,” “an exemplary embodiment,” etc., indicate that the embodiment described may include a particular feature, structure, or characteristic, but not every embodiment may necessarily include that feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to implement such feature, structure, or characteristic in connection with other embodiments whether explicitly described.

In the interest of not obscuring the presentation of the exemplary embodiments of the present inventive concept, in the following detailed description, some processing steps or operations that are known in the art may have been combined for presentation and for illustration purposes, and in some instances, may have not been described in detail. Additionally, some processing steps or operations that are known in the art may not be described at all. The following detailed description is focused on the distinctive features or elements of the present inventive concept according to various exemplary embodiments.

The present inventive concept provides for a method of apparatus static inertia compensation using external robots. For example, wind turbine blades stop rotating when wind speed is insufficient to produce a wind turbine cut-in speed, and if wind speed is increased gradually, then the wind turbines can resume rotation. Wind turbines have variable specifications and mechanical conditions. Wind speed/force necessary to generate wind turbine cut-in speeds are not uniform. Thus, a method and system to overcome the static inertia with the wind turbines is needed so that cut-in speeds can be preserved, cut-out speed shutdowns can be avoided, and wind turbine power production can be maximized to enhance their practicality.

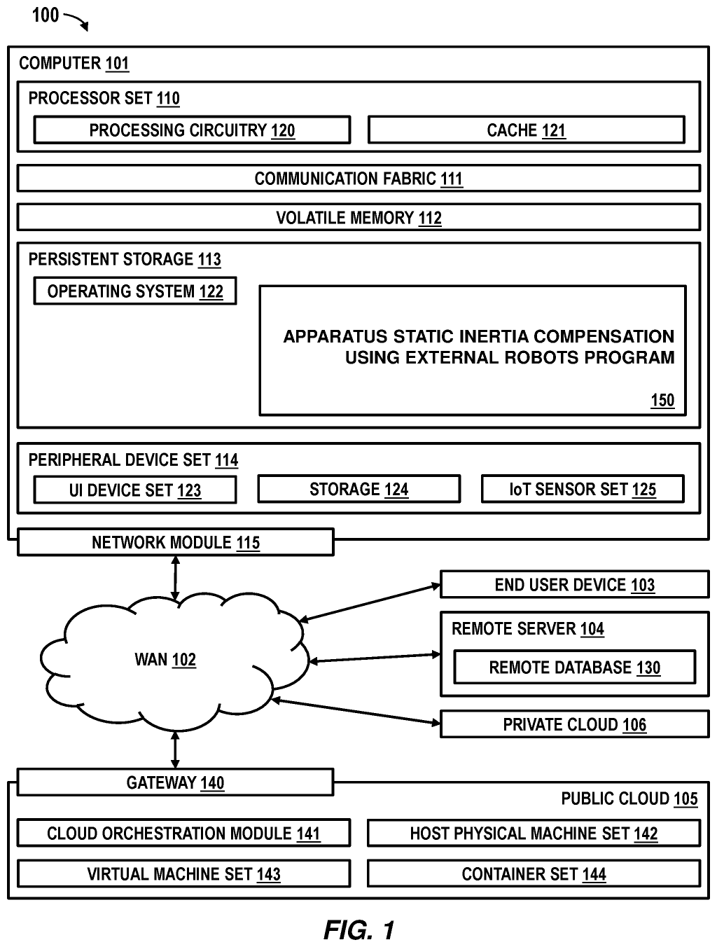

FIG. 1 illustrates a schematic diagram of computing environment 100 including the apparatus static inertia compensation using external robots program 150, in accordance with an exemplary embodiment of the present inventive concept.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as the apparatus static inertia compensation using external robots program 150. In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

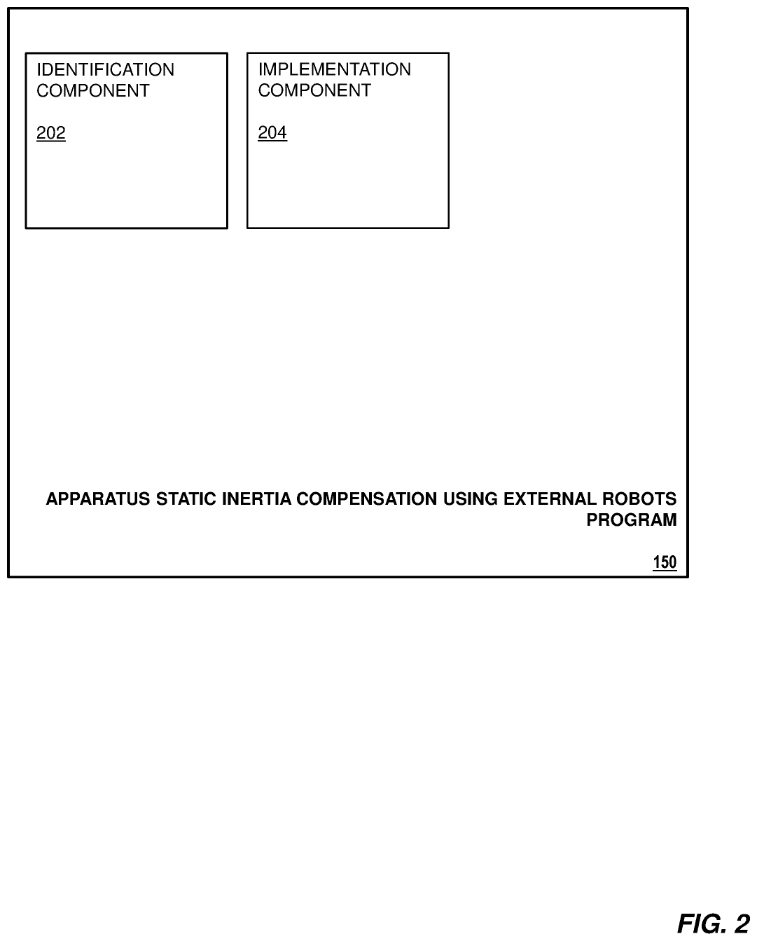

FIG. 2 illustrates a block diagram of components included in the apparatus static inertia compensation using external robots program 150, in accordance with an exemplary embodiment of the present inventive concept.

The identification component 202 can identify at least one wind turbine and at least one corresponding position thereof and/or at least one flight-enabled external robot (if available) associated with a predetermined operation/location (e.g., wind farm) by reference to a repository (e.g., inventory including the at least one wind turbine and available external robots) and/or using machine learning of relevant multimedia (e.g., computer vision and/or natural language processing (NLP)). The identification component 202 can obtain real-time and/or prior sensor (e.g., anemometer, device/components, hygrometer, etc.) measurements from the repository and/or raw multimedia related to operation of the at least one wind turbine and/or the at least one external robot (e.g., location weather, wind turbine/external robot maintenance logs, wind turbine/external robot device/component manufacturer information, wind turbine/external robot capabilities (e.g., power outputs), etc.). The identification component 202 can extract and map features from the raw multimedia data and/or identify corresponding times (e.g., clock time, day, week, month, season, year etc.) using machine learning processes. The weather features can include wind attributes (e.g., speeds, variability, directions, pressures, etc.), precipitation (e.g., types, quantities, qualities, etc.), temperature, atmospheric pressure, humidity, etc. The maintenance log features can include maintenance types (e.g., device/component, inspection, cleaning, repair, lubrication, component replacement, etc.), involved component identities (e.g., foundation, tower, rotor, anemometer, hub, wind turbine blades, the nacelle, generator, etc.) and conditions thereof, scheduled maintenance tasks and/or hallmarks/times therefor, etc. The wind turbine/component manufacturer features can include cut-in/cut-out speeds and/or ranges, weights, power outputs, torques, dimensions (e.g., usage, height, length, width, depth, surface areas, curvatures, shapes, etc.), manufacturer identities, suggested maintenance times/hallmarks, recalls, common issues, etc. The extracted power output features can include energy, force, power, and/or efficiency of the at least one wind turbine and/or the at least one external robot. The identification component 202 can determine predictive patterns (e.g., times of insufficient wind speed for cut-in speed or excess wind speed for cut-out, affect of high humidity, decreased efficiency from lack of maintenance/wear-and-tear, etc.) from the mapped extracted features. The identification component 202 can identify a position of at least one wind turbine experiencing static inertia, such as by identifying wind speed (actual or predicted) and/or decreased/stopped power output of the at least one wind turbine (actual or predicted).

For example, the identification component 202 identifies a plurality of wind turbines located in a region of a predetermined wind farm. The identification component 202 obtains repository device/component inventory/maintenance data, weather forecasts/almanac multimedia via a network, wind turbine sensor measurements, power outputs, and wind turbine/component manufacturer data via the network, extracts features, and maps them. The identification component 202 determines that rain is predicted in the evening, which is prone to subsequent freezing this time of year (winter) and interferes with the rotor operation, wind speed drops below cut-in speed most often in the late afternoon and exceeds cut-out speed in the early morning. The identification component also determines that maintenance is up to date on the wind turbines and external robots, but that several of the wind turbines are approaching scheduled replacement and are experiencing decreased power output of approximately 15%. The external robots, however, are producing the manufacturer published power outputs. The identification component 202 determines that the several wind turbines in need of imminent replacement are presently experiencing static inertia in the early morning.

The implementation component 204 can compare the identified wind speed to the predetermined cut-in/cut-out speeds. The implementation component 204 can determine at least one cause of the at least one wind turbine actually and/or imminently stopped due to static inertia and/or excess wind. The implementation component 204 can determine the actual and/or predicted weather conditions at the location and/or a region thereof (e.g., wind speed, humidity, precipitation, temperature, etc.) from the mapped features and/or the identified patterns, at least one action necessary to overcome/hinder actual and/or imminent static inertia (e.g., apply force, obstruct/redirect wind, thaw frozen components, etc.), magnitudes/durations/expenses thereof, available/suggested external robots for performing the necessary action and quantities thereof, and/or times/orientations/angles/positions (e.g., attachment sites, regions to mobilize, components to hover adjacent to, etc.) thereof. The implementation component 204 can determine necessary capabilities of the external robots to perform the at least one necessary action. The implementation component 204 can calculate a cost of the necessary action and compare it to a predetermined threshold. The implementation component 204 can determine times/orientations/angles/positions which will permit the least resources (e.g., gasoline, electricity, external robots, etc.) to be used to perform the at least one necessary action (e.g., maximum torque/minimum force). The implementation component 204 can monitor the efficacy of performed necessary actions in real-time and/or from feedback related to preventing/overcoming static inertia and adjust/troubleshoot/learn accordingly.

For example, the implementation component 204 determines that the wind speed in the region of the several wind turbines stopped due to static inertia is 55 mph, which is the lower end of the threshold range for cut-out speed. The implementation component 204 deploys 3 necessary external robots to the region with the several wind turbines to attach to the wind turbine blade ends and apply the calculated maximum torque/minimum force necessary to prevent cut-out in a substantially perpendicular direction to the plane of the wind turbine blades. The external robots subsequently perform a wind shielding function using equipped apparatuses. Several hours later in the late morning, the implementation component 204 determines that the several wind turbines are experiencing static inertia again and mobilizes an external robot to apply heat to the rotor given recent rain and sub-freezing temperatures, which is successful, and learns accordingly. In the late afternoon, the implementation component 204 mobilizes the external robots to apply a maximum torque/minimum force necessary to overcome the predicted below cut-in wind speeds of 5 mph in a substantially perpendicular direction to the plane of the wind turbine blades. However, the wind turbine fails to rotate at forces equivalent to 6 mph. The implementation component 204 determines that the cause is most probably inefficiency due to approaching replacement and adjusts the applied force to the equivalent of 9 mph, which is successful, and learns accordingly.

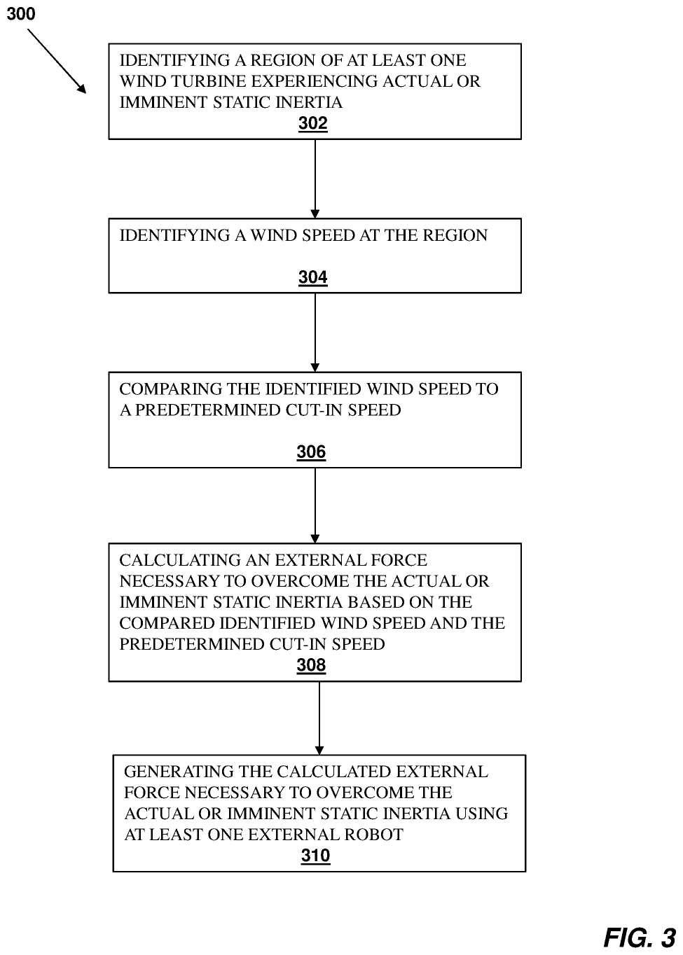

FIG. 3 illustrates a flowchart of apparatus static inertia compensation using external robots 300, in accordance with an exemplary embodiment of the present inventive concept.

The apparatus static inertia compensation using external robots 300 can include steps for:
Identifying a region of at least one wind turbine experiencing actual or imminent static inertia (step 302);
Identifying a wind speed at the region (step 304);
Comparing the identified wind speed to a predetermined cut-in speed (step 306);
Calculating an external force necessary to overcome the actual or imminent static inertia based on the compared identified wind speed and the predetermined cut-in speed (step 308); and
Generating the calculated external force necessary to overcome the actual or imminent static inertia using at least one external robot (step 310).

Based on the foregoing, a computer system, method, and computer program product have been disclosed. However, numerous modifications, additions, and substitutions can be made without deviating from the scope of the exemplary embodiments of the present inventive concept. Therefore, the exemplary embodiments of the present inventive concept have been disclosed by way of example and not by limitation.

What is claimed is:

1. A method of apparatus static inertia compensation using external robots, the method comprising:
identifying a region of at least one wind turbine experiencing actual or imminent static inertia;
identifying a wind speed at the region;
comparing the identified wind speed to a predetermined cut-in speed;
calculating an external force necessary to overcome the actual or imminent static inertia based on the compared identified wind speed and the predetermined cut-in speed; and
generating the calculated external force necessary to overcome the actual or imminent static inertia using at least one external robot.

2. The method of claim 1, wherein the generated calculated external force is applied to at least one blade of the wind turbine by the at least one external robot.

3. The method of claim 1, wherein the at least one external robot is flight-capable.

4. The method of claim 1, wherein the calculated external force is based in part on a mechanical condition of the wind turbine.

5. The method of claim 1, further comprising:
determining a necessary quantity of external robots, orientation, and attachment sites to generate the calculated external force.

6. The method of claim 5, wherein the determined necessary quantity of external robots includes at least robot for each wind turbine blade, and wherein the generated calculated external force is applied perpendicular to a respective wind turbine blade axis.

7. The method of claim 6, wherein the external robots include at least one propeller, and wherein the generated calculated external force is produced by the at least one propeller.

8. A computer program product (CPP) for apparatus static inertia compensation using external robots, the CPP comprising:
one or more computer-readable storage media and program instructions stored on the one or more non-transitory computer-readable storage media capable of performing a method, the method comprising:
identifying a region of at least one wind turbine experiencing actual or imminent static inertia;
identifying a wind speed at the region;
comparing the identified wind speed to a predetermined cut-in speed;
calculating an external force necessary to overcome the actual or imminent static inertia based on the compared identified wind speed and the predetermined cut-in speed; and
generating the calculated external force necessary to overcome the actual or imminent static inertia using at least one external robot.

9. The CPP of claim 8, wherein the generated calculated external force is applied to at least one blade of the wind turbine by the at least one external robot.

10. The CPP of claim 8, wherein the at least one external robot is flight-capable.

11. The CPP of claim 8, wherein the calculated external force is based in part on a mechanical condition of the wind turbine.

12. The CPP of claim 8, further comprising:
determining a necessary quantity of external robots, orientation, and attachment sites to generate the calculated external force.

13. The CPP of claim 12, wherein the determined necessary quantity of external robots includes at least robot for each wind turbine blade, and wherein the generated calculated external force is applied perpendicular to a respective wind turbine blade axis.

14. The CPP of claim 13, wherein the external robots include at least one propeller, and wherein the generated calculated external force is produced by the at least one propeller.

15. A computer system (CS) for apparatus static inertia compensation using external robots, the CS comprising:
one or more computer processors, one or more computer-readable storage media, and program instructions stored on the one or more of the computer-readable storage media for execution by at least one of the one or more processors capable of performing a method, the method comprising:
identifying a region of at least one wind turbine experiencing actual or imminent static inertia;
identifying a wind speed at the region;
comparing the identified wind speed to a predetermined cut-in speed;
calculating an external force necessary to overcome the actual or imminent static inertia based on the compared identified wind speed and the predetermined cut-in speed; and
generating the calculated external force necessary to overcome the actual or imminent static inertia using at least one external robot.

16. The CS of claim 15, wherein the generated calculated external force is applied to at least one blade of the wind turbine by the at least one external robot.

17. The CS of claim 15, wherein the at least one external robot is flight-capable.

18. The CS of claim 15, wherein the calculated external force is based in part on a mechanical condition of the wind turbine.

19. The CS of claim 15, further comprising:
determining a necessary quantity of external robots, orientation, and attachment sites to generate the calculated external force.

20. The CS of claim 19, wherein the determined necessary quantity of external robots includes at least robot for each wind turbine blade, and wherein the generated calculated external force is applied perpendicular to a respective wind turbine blade axis.
